(19) United States
(12) Patent Application Publication
(10) Pub. No.: US 2009/0023338 A1
(43) Pub. Date: Jan. 22, 2009

(54) Electrical connector and method of making the same

(75) Inventors: Jia-Yong He, Kunshan (CN); Qi-Sheng Zheng, Kunshan (CN)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/220,194

(22) Filed: Jul. 21, 2008

(30) Foreign Application Priority Data
Jul. 19, 2007 (CN) 200710024184.5

(51) Int. Cl. H01R 13/648; H01R 43/00; H01R 24/00

(52) U.S. Cl. 439/607; 29/883; 439/676

(57) ABSTRACT

An electrical connector (1) includes a contact module (2). The contact module (2) includes a plurality of contacts (213) and a contact base (22) insert molding around the contacts (213). A metal shield (3) encloses the contact module (2). Wherein the contact base (22) is formed with a base portion (221) and a tongue (222) extending from the base portion (221) forwardly. The tongue (222) has a front face (2220) and a plurality of passageways (225) to position the contacts (213). The passageways (225) extend through the front face (2220) of the tongue (222).

### BACKGROUND OF THE INVENTION

1. Field of the Invention

The present invention relates to an electrical connector and method of making the same, and more particularly to an electrical connector made by a method of insert molding.

2. Description of Related Art

With the development of the electrical industry, electrical connectors are employed widely with peripherals to transmit various signals with each other. As we know, the electrical industry trends to a miniature development, the space which the electrical connector occupies is less and less. Thereby, the electrical connector trends to a miniature development also. A conventional electrical connector usually comprises an insulative housing, a plurality of contacts retained in the insulative housing and a metal shield. The insulative housing defines a plurality of contact passageways. In conventional methods for manufacturing the electrical connector, an inserting method is adopted to insert rows of contacts into the passageways of the insulative housing from a rear end. The contacts are then forced into the housing. The contacts are manufactured by means of stamping.

However, such an inserting method will damage the mechanical and electrical performance of the electrical connector. Especially in a miniature electrical connector, the contacts and contact passageways are arranged closely. Side walls of the contact passageways are weak. Since the contacts interferentially engage with the side walls of the contact passageways, the contacts may wear away surfaces of the side walls. Thereby, the adjacent contacts will contact with each other and adversely affect signal transmission.

In order to solve above problem, insert molding an insulative housing around the contacts directly is preferred; The contacts will be partially enclosed by insulative material for preventing disturbance from each other. In process of manufacturing such an electrical connector, stamping a plurality of contacts with a carrier joined with one end thereof firstly, then fixing the contacts into a mold by the carrier and filling melting insulative material into the mold, a contact module will be formed. An electrical connector is formed after cutting out the carrier. However, in the process of filling insulative material of high temperature into the mold, the contacts are just fixed at one end by the carrier, the insulative material will strike the contacts to contact with each other as the contacts is arranged closely with each other. Thereby, it will bring crosstalk in signal transmission. In addition, another end of the contacts is not fixed by insulative material after the contact module formed, which can not ensure the coplanarity of the contacts.

Hence, an electrical connector and method of making the same are desired to overcome the disadvantage of the prior art.

### BRIEF SUMMARY OF THE INVENTION

According to one aspect of the present invention, an electrical connector comprises a contact module. The contact module comprises a plurality of contacts and a contact base insert molding around the contacts. A metal shield encloses the contact module. The contact base is formed with a base portion and a tongue extending from the base portion forwardly. The tongue has a front face and a plurality of passageways to position the contacts. The passageways extend through the front face of the tongue.

According to another aspect of the present invention, a method of making an electrical connector comprises stamping and forming a contact carrier strip. The contact carrier strip comprises a plurality of contacts, a first carrier and a second carrier connecting with two ends of the contacts. Depositing the contact carrier strip in predetermined position of a mold via the first and second carrier, and insert molding a contact base around appropriate portions of the contacts received in the mold to form a contact module. The contact base is formed with a base portion and a tongue. The tongue is formed with a plurality of passageways extending to a front end thereof. Each passageway corresponds to each contact and fixes one end of the contact therein. Wherein each contact comprises a contact portion joined with the first carrier, a soldering portion joined with the second carrier, and a securing portion retained in the contact base.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a contact carrier strip of an electrical connector according to the present invention;

FIG. 2 is a perspective view of a contact module with two carriers of the electrical connector;

FIG. 3 is a view similar to FIG. 2, while taken from another aspect;

FIG. 4 is a perspective view of a contact module without carriers of the electrical connector;

FIG. 5 is a cross-sectional view taken along line 5-5 of FIG. 4;

FIG. 6 is an exploded view of the electrical connector;

FIG. 7 is a view similar to FIG. 6, while taken from another aspect;

FIG. 8 is a perspective view of the electrical connector.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

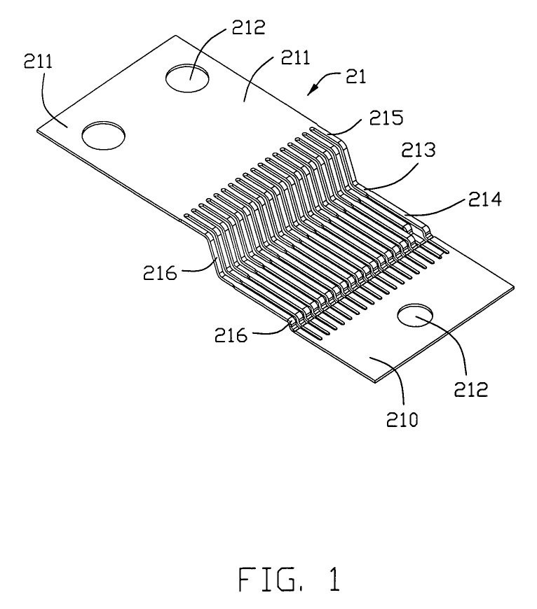

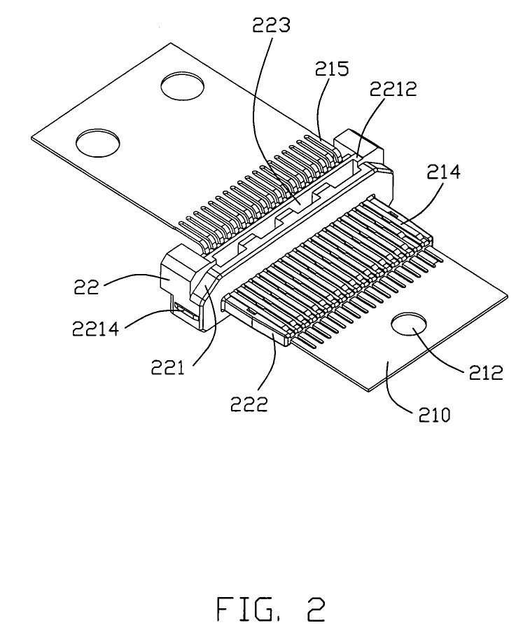

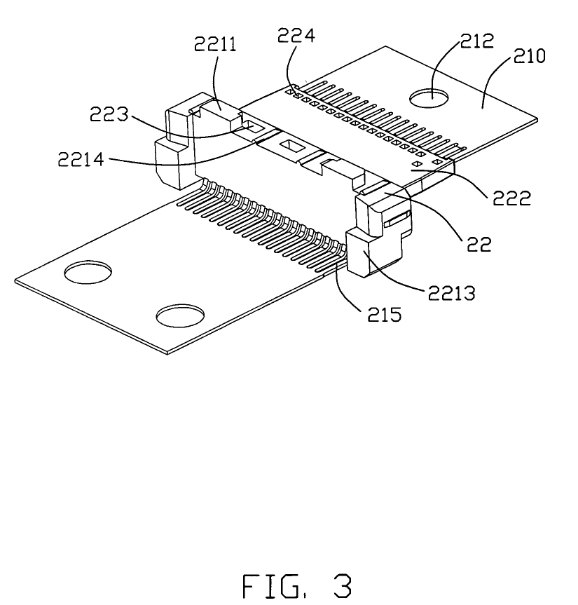

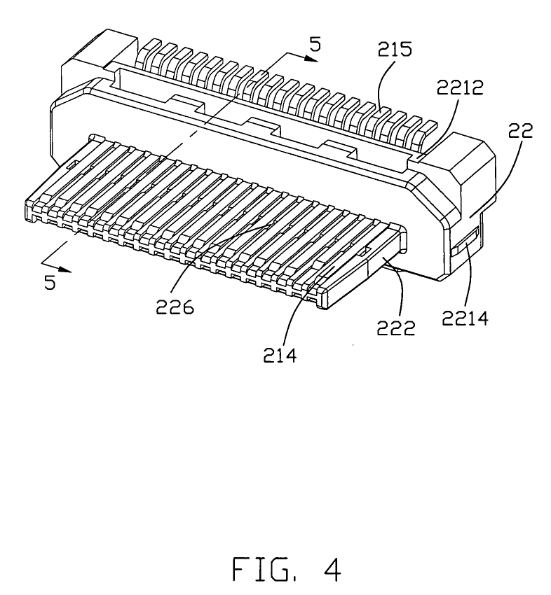

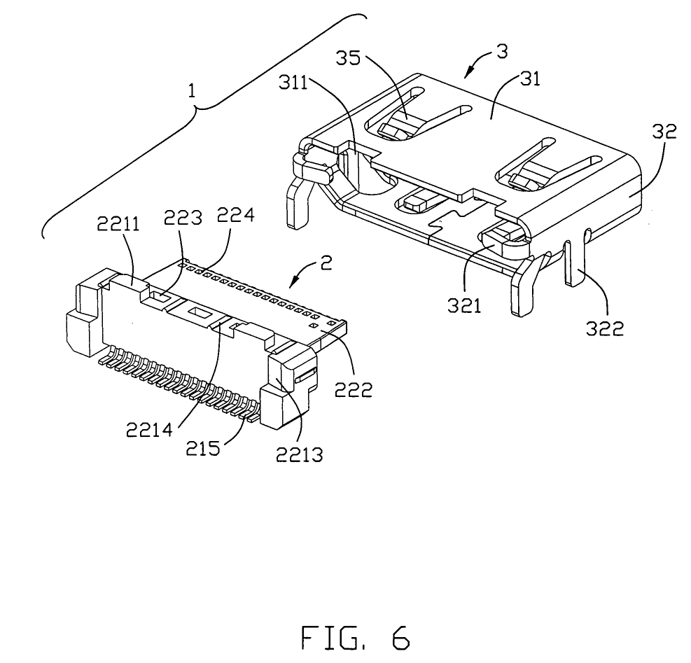

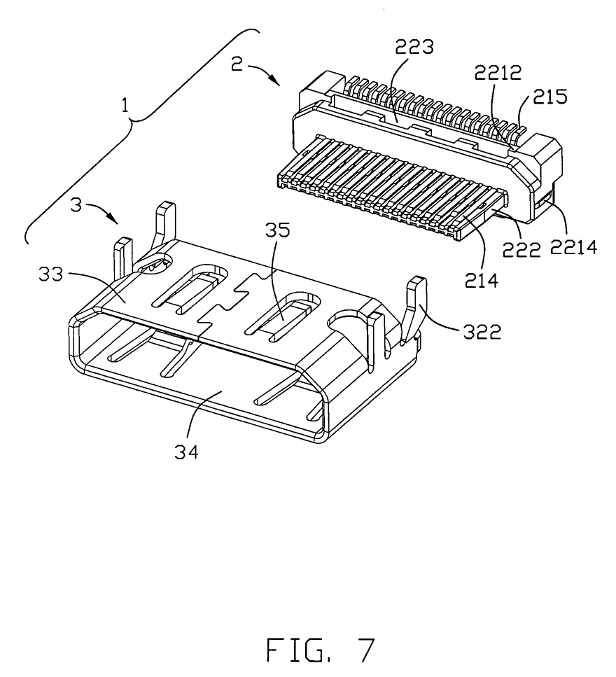

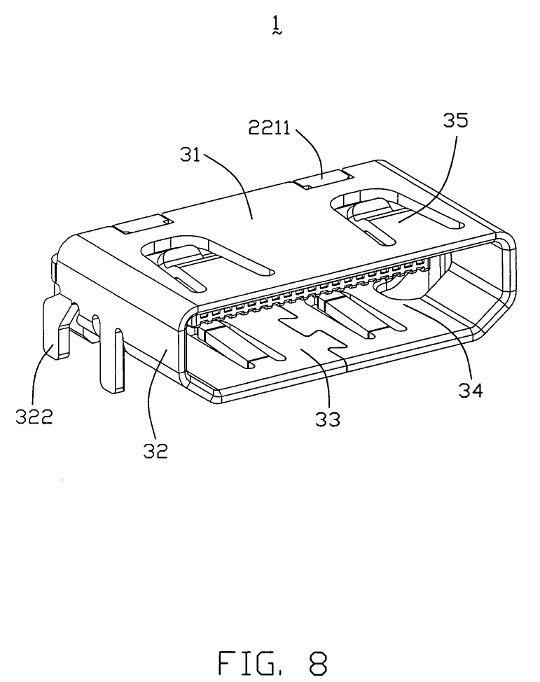

Referring to FIGS. 1-8, an electrical connector 1 for receiving a corresponding plug (not shown) is disclosed in accordance with the present invention. The electrical connector 1 comprises a contact module 2 and a metal shield 3 enclosing the contact module 2.

The contact module 2 comprises a plurality of contacts 213 and a contact base 22 insert molded with the contacts 213. A method of making the contact module 2 comprises five steps as follows. Firstly, stamping a piece of metal sheet to a contact carrier strip 21. The contact carrier strip 21 comprises a plurality of contacts 213 arranged at a row along a left to right direction, a first carrier 210 and a second carrier 211 connecting with two opposite ends of the contacts 213. The first and second carriers 210, 211 are formed with a plurality of openings 212 for positioning the contact carrier strip 21 in a mold (not shown). The contacts 213 comprise a plurality of long contacts and a short contact located between the long contacts. Each contact 213 is formed with a contact portion 214 joined with the first carrier 210, a soldering portion 215 joined with the second carrier 211, and two securing portions 216 located between the contact portion 214 and the soldering portion 215 and located at a front end of the contact portion 214.

Secondly, depositing the contact carrier strip 21 in a predetermined position of the mold via the first and second carrier 210, 211, the mold comprises a plurality of first posts engaging with the openings 212. The mold has a plurality of pins located between the contact portions 214 of the contacts 213 for preventing the adjacent contacts 213 from contacting with each other, and a plurality of second posts pressing two sides of the contact portions 214 along an up to down direction for preventing the contact portions 214 from moving along the up to down direction. Thereby, the contact carrier strip 21 can be positioned by the mold firmly. The contacts 213 will not contact with each other to ensure the signal transmission of the electrical connector 1.

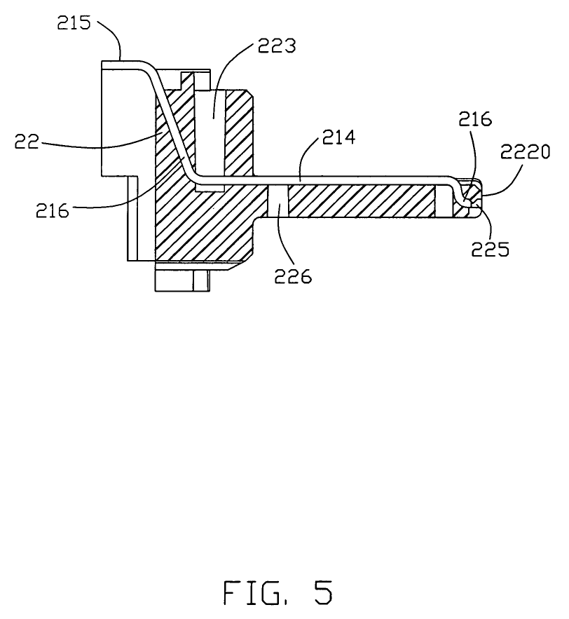

Thirdly, insert molding melted insulative material around appropriate portions of the contacts 213 received in the mold, a contact base 22 will be formed around the contacts 213. The contact base 22 is formed with a base portion 221 and a tongue 222 extending forwardly from the base portion 221. The tongue 222 has a front face 2220. Referring to FIG. 5, the securing portions 216 between the contact portions 214 and the soldering portions 215 are retained in the base portion 221. A plurality of passageways 225 are formed in the tongue 222 and extend forwardly through the front face 2220. The contact portions 214 of the contacts 213 are partially received in the passageways 225, and partially exposed on a surface of the tongue 222 for electrically connecting with a corresponding plug (not shown). The securing portions 216 which are located at the front end of the contact portions 214 are retained in the passageways 225 of a front end. Thereby, the passageways 225 surround and fix the front end of the contacts 213 for ensuring the coplanarity of the contact portions 214. The contact portions 214 would not turn up or distort as cutting out the first carrier 210 from the contact carrier strip 21.

The base portion 221 is formed with a plurality of slots 223 at an upper portion and a lower portion thereof. The slots 223 are staggered with each other. The mold comprises a plurality of posts at the position of the slots 223 for promoting the movement of the melted insulative material. In addition, the tongue 222 is formed with a plurality of first holes 224 at a front position thereof, and a plurality of the second holes 226 at a rear end thereof. The first and second holes 224, 226 extend through the tongue 222 along the up to down direction. Each first hole 224 locates at the position of each second post of the mold and corresponds to each contact 213. Each second hole 226 locates at the position of each pin and between adjacent contacts 213. The base portion 221 is formed with a pair of protrusions 2211 and ribs 2214 at the upper position thereof. The base portion 221 has a projection 2212 extending inwardly at the lower portion, and a step portion 2213 extending backwardly from each side thereof.

Fourthly, cutting out the first and second carriers 210, 211, the soldering portions 215 are arranged in a common surface and parallel to the contact portions 214.

Fifthly, assembling a metal shield 3 around the contact module 2 after cutting out the first and second carriers 210, 211, the electrical connector 1 is formed. The metal shield 3 is made of a piece of metal sheet. A front end of the metal shield 3 presents as D shape. The metal shield 3 comprises a top wall 31, a pair of side walls 32, a lower wall 33 and a receiving space 34 there between. Each upper and lower wall 31, 33 has a pair of spring arms 35 for engaging with the corresponding plug. The upper wall 31 defines a pair of apertures 311 for receiving the protrusions 2211. A rear end of the lower wall 33 abuts against the projection 2212 of the base portion 221. Each side wall 31 has a locking barb 321 bending inwardly for locking with the step portion 2213 for moving along a front to back direction. The inside of the metal shield 3 engages with the ribs 2214 for firmly covering the contact module 2. Each side wall 32 comprises a pair of mounting leg 322 for fixing to a circuit board (not shown).

According to the present invention, the contact base 22 is insert molded around the contacts 213, thereby, the contact base 22 will not be worn away as inserting the contacts therein. The contacts 213 join with the first and second carriers 210, 211 at two ends thereof, therefore the contacts 213 will not move in the process of insert molding insulative material there around. In addition, the securing portions 216 at the front end of the contact portions 214 are retained in the passageways 225. The coplanarity of the contact portions 214 can be ensured. The quality of the electrical connector 1 will be ensured also.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. An electrical connector, comprising:
a contact module comprising a plurality of contacts and a contact base insert molded around the contacts; and
a metal shield enclosing the contact module;
wherein the contact base is formed with a base portion and a tongue extending forwardly, the tongue having a front face and a plurality of passageways to position the contacts, the passageways extending through the front face of the tongue.

2. The electrical connector according to claim 1, wherein the passageways surrounds the front end of the contact for positioning the contact therein.

3. The electrical connector according to claim 2, wherein each contact comprises a contact portion partially exposed on a surface of the tongue, a soldering portion extending out of the contact base, and a securing portion insert molded in the base portion.

4. The electrical connector according to claim 1, wherein the base portion defines a plurality of slots at an upper portion and a lower portion, the slots being stagger with each other.

5. The electrical connector according to claim 1, wherein the tongue is formed with a plurality of first holes located at a front position thereof, each first hole corresponding to each contact and extending through the tongue along an up to down direction.

6. The electrical connector according to claim 1, wherein the tongue is formed with a plurality of second holes located at a rear position thereof, each second hole located between adjacent two contacts and extending through the tongue.

7. The electrical connector according to claim 1, wherein the contacts comprises a plurality of long contacts and a short contact.

8. The electrical connector according to claim 1, wherein the metal shield defines a receiving space for receiving a corresponding plug, the frond end of the metal shield presenting as D shape.

9. A method of making an electrical connector, comprising:
stamping and forming a contact carrier strip, the contact carrier strip comprising a plurality of contacts, a first carrier and a second carrier connecting with two end of the contacts;
depositing the contact carrier strip in predetermined position of a mold via the first and second carriers; and
insert molding a contact base around appropriate portions of the contacts received in the mold to form a contact module, the contact base being formed with a base portion and a tongue, the tongue being formed with a plurality of passageways extending to a front end thereof, each passageway corresponding to each contact;
cutting out the first and second carriers;
wherein each contact comprises a contact portion joined with the first carrier, a soldering portion joined with the second carrier, and a securing portion retained in the contact base.

10. The method of making the electrical connector according to claim 9, wherein the passageways surrounds the front end of the contact for positioning the contact therein.

11. The method of making the electrical connector according to claim 9, wherein the contacts is formed with a plurality of long contacts and a short contact.

12. The method of making the electrical connector according to claim 9, wherein the tongue is formed with a plurality of holes extending therethrough along an up to down direction.

13. The method of making the electrical connector according to claim 9, wherein the base portion is formed with a plurality of slots at an upper portion and lower portion.

14. The method of making the electrical connector according to claim 9, further comprising assembling a metal shield on the contact module, wherein the front end of the metal shield presents as D shape.

15. An electrical connector comprising:
an insulative housing including a mating tongue forwardly extending in a horizontal direction;
a plurality of contacts integrally formed with the housing via an insert molding procedure, each of said contacts having a flat contacting section extending along an exterior face of the mating tongue and exposed to an exterior in a first vertical direction perpendicular to said mating tongue, front and rear securing sections respectively located by two ends of said contacting section and embedded within the housing, a tail section extending rearwardly from the rear securing section, wherein
a plurality of openings formed in a front edge region of the mating tongue and inwardly communicating with the corresponding front securing sections, respectively, under a condition that each of said openings communicates with the exterior such that via said openings it allows separation of the front securing sections of the contacts and an associated carrier after the contacts have been integrally formed with the housing.

16. The electrical connector as claimed in claim 15, wherein each of said openings communicates with the exterior in at least said horizontal direction.

17. The electrical connector as claimed in claim 16, wherein each of said openings further communicates with the exterior in second vertical direction.

18. The electrical connector as claimed in claim 17, wherein said second direction is not same with the first direction but opposite to the first direction.
